(19) United States
(12) Patent Application Publication
(10) Pub. No.: US 2026/0298277 A1
(43) Pub. Date: Oct. 1, 2026

(54) SELF-TAPPING SCREW

(71) Applicant: Knapp Holding GmbH, Euratsfeld (AT)

(72) Inventor: Friedrich KNAPP, Bad Kreuzen (AT)

(73) Assignee: Knapp Holding GmbH, Euratsfeld (AT)

(21) Appl. No.: 19/477,827

(22) PCT Filed: Mar. 19, 2024
(86) PCT No.: PCT/EP2024/057243

§ 371 Date: Oct. 23, 2025

(30) Foreign Application Priority Data
May 9, 2023 (EP) 23172336.2

(51) Int. Cl. F16B 25/00

(52) U.S. Cl. CPC F16B 25/0015; F16B 25/0073; F16B 25/0078

(57) ABSTRACT

A self-tapping screw has a cylindrical shaft with a central axis, to which cylindrical shaft a conical tip is coaxially contiguous, and a radially projecting cutting rib, which runs helically in windings over the shaft and the tip. The distance between two adjacent windings in axial direction is the pitch of the screw. The shaft is provided with a lateral recess, which interrupts at least one winding of the cutting rib and penetrates into the shaft up to at most half its diameter. The tip is free of any recess and the end of the recess facing away from the tip has a distance from the tip which is at most five pitches.

### CROSS-REFERENCE TO RELATED APPLICATION/S

This application is a National Phase application of International Application No. PCT/EP2024/057243 filed Mar. 19, 2024 which claims priority to the European Patent Application No. 23 172 336.2 filed May 9, 2023, the disclosures of which are incorporated herein by reference.

### TECHNICAL FIELD

The present disclosed subject matter relates to a self-tapping screw having a cylindrical shaft with a central axis, to which cylindrical shaft a conical tip is coaxially contiguous, and a radially projecting cutting rib, which runs helically in windings over the shaft and the tip, wherein the distance between two adjacent windings in the axial direction is the pitch of the screw, and wherein the shaft is provided with a lateral recess, which interrupts at least one winding of the cutting rib and penetrates into the shaft up to at most half its diameter.

### BACKGROUND ART

Screws Of this type are known, for example, from documents AU 200027716 Al and CN 201747735 U. The interruption of the cutting rib by the recess creates a sharp cutting tip per turn, which acts in the circumferential direction and facilitates the cutting of the thread into a component when the screw is being screwed in.

Numerous embodiments of such cutting recesses are known in the prior art. The known solutions have the disadvantage to either weaken the screw excessively, provide too little cutting support, or decenter the screw when the same is being screwed in.

### BRIEF SUMMARY

It is the object of the disclosed subject matter to overcome these disadvantages and create an improved self-tapping screw.

This object is achieved by a self-tapping screw of the type mentioned in the outset which distinguishes according to the disclosed subject matter in that the tip is free of any recess and in that the end of the recess facing away from the tip has a distance from the tip which is at most five pitches.

The cutting recess according to the disclosed subject matter solves several problems of self-tapping screws at once. Since the recess does not extend into the tip, the centering effect of the tip remains unimpaired when the screw is being screwed in. On the other hand, the recess is located immediately behind the tip, that is, so far forward on the screw that it weakens the torsional strength of the screw when the same is being screwed in and its tensile strength in the screwed-in state as little as possible. The part of the screw which is located between the recess and the tip and which is connected via the weakened area of the shaft left by the recess is also minimized, as is the number of windings which are present on this part and subject to circumferential friction during the screwing-in process. At the same time, the position of the recess behind the tip ensures that the cutting rib already cuts the thread into the component with the full outer diameter, which improves the cutting action.

The screw according to the disclosed subject matter cuts the its thread into the component particularly gently, thus reducing the risk of splitting or breaking the component during screwing-in, in particular when the component is made of wood. This means that the minimum distance to be maintained from the component edge can be reduced. This is a particular advantage in timber engineering, for example when connecting main, secondary, or cross beams, cross braces, trusses, supports, posts, walls, or the like. The components to be connected here are usually made of glued laminated timber (GLT), and it is indispensable to adhere to minimum edge distances for screw joints to prevent the wood from splitting. Smaller minimum edge distances allow the use of smaller wood cross-sections at the same strength, which reduces costs and simplifies handling.

Optionally, the end of the recess facing away from the tip has a distance from the tip which is at most than four pitches. As a result, the cutting recess is located particularly close to the tip, so that the torsional and tensile strength of as large a part of the screw as possible is not impaired by the cutting recess.

In a particularly advantageous embodiment, the end of the recess facing the tip has a distance from the tip which is at least a half pitch and at most three pitches, e.g. one to two pitches. This leaves a very short area between the tip and the recess, in which only very few, but a sufficient number of full-diameter windings of the cutting rib are present, which facilitates the centering of the screw during screwing-in.

Viewed in the axial direction, the recess can, for example, have the shape of a circular segment. This can be produced particularly easily by grinding, milling, rolling, embossing, or upsetting. As an alternative, the recess, viewed in the axial direction, can have the shape of a circular sector, for example, a third, a quarter, a fifth, and so forth of a circle. For example, several recesses could also be provided at different circumferential positions of the shaft.

Optionally, the recess, viewed perpendicular to a plane containing the axis, has the shape of a rectangle, a circular segment or an ellipsoidal segment. These shapes can also be easily produced by milling, grinding, rolling, embossing or upsetting.

In a further optional embodiment of the disclosed subject matter, the projecting height of the cutting rib on the tip progressively decreases to the apex of the tip. This measure facilitates the centering and cutting of the thread into the component when screwing in the screw, while at the same time protecting the component as much as possible.

It is particularly favorable when the penetration depth of the recess is 10 to 50% of the diameter of the shaft, e.g. 35 to 45%. This yields an excellent compromise between minimizing the weakening action of the recess on the one hand and maximizing its cutting effect on the other hand.

In all of these embodiments, it is optionally possible for the shaft to transition at its end facing away from the tip, via a widening transition section, into a cylindrical section with a larger diameter than the shaft, to which section a head for the engagement of a tool is contiguous. The widened cylindrical section can be used as a guide section for the screw in a fitting with a cylindrical bore and provides good force introduction from the head to the shaft during screwing-in.

The head, e.g., has a larger diameter than the section, and a shoulder is formed between the head and the section. The shoulder can be used as a bearing surface for a fitting that is screwed to a component using the screw. At the same time, the widened head provides sufficient space for a hexagon socket, a six-lobe screw bit, or the like for the engagement of a corresponding tool.

### BRIEF DESCRIPTION OF THE DRAWINGS/FIGURES

The disclosed subject matter will be described hereafter in greater detail based on exemplary embodiments shown in the accompanying drawings. In the drawings:

FIG. 1 shows a first embodiment of the screw of the disclosed subject matter in a side view;

FIG. 2 shows the screw of FIG. 1 in an oblique view from above;

FIG. 3 shows a second embodiment of the screw of the disclosed subject matter in an axially normal section at the level of the recess;

FIG. 4 shows a third embodiment of the screw of the disclosed subject matter in an axially normal section analogous to FIG. 3; and

FIG. 5 shows a fourth embodiment of the screw f the disclosed subject matter in a side view.

### DETAILED DESCRIPTION

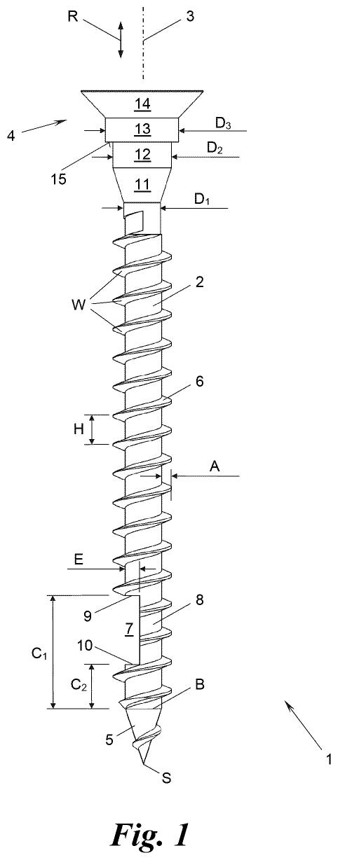

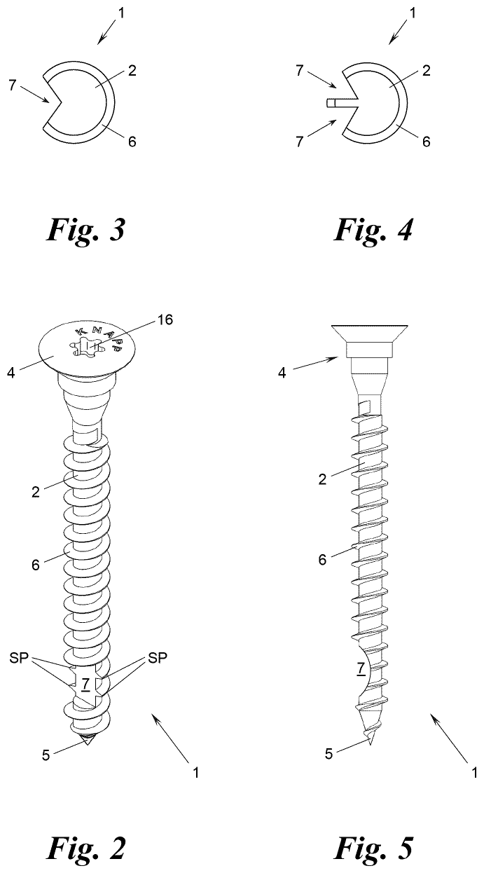

FIGS. 1 and 2 show a self-tapping screw 1 to be screwed or turned into a component (not shown) made of, for example, wood or plastic. The screw 1 has a cylindrical shaft 2 with a central axis 3. At one (rear) end, a head 4 is contiguous to the shaft 2, and at the other (front) end, a conical tip 5 with a base collar B and an apex S is contiguous to the shaft. A cutting rib 6 runs helically in several windings W around and over the shaft 2 and the tip 5. Each winding W, viewed in the direction of the axis 3, this being the axial direction R, runs 360° around the axis 3. The distance between two adjacent windings 3 in the axial direction R is the pitch H of the screw 1.

In a longitudinal section containing the axis 3, the cutting rib 6 approximately has a triangular or trapezoidal shape and projects from the surface of the shaft 2 or the surface of the tip 5, measured perpendicular to the axis 3, by a projecting height A. The projecting height A from the shaft 2 is 5 to 20% of the diameter Di of the shaft 2. On the tip 5, the cutting rib 6 gradually tapers off in the apex S, that is, its projecting height A on the top 5 progressively decreases from the base B contiguous to the shaft 2 to the apex S of the tip 5, wherein it can already reach the value zero before the apex S, as shown in FIG. 1.

The shaft 2, including the helical cutting rib 6 running thereon, is provided with a lateral recess 7, which interrupts at least one winding W of the cutting rib 6.

The recess 7 leaves cutting tips SP from the cutting rib 7 where it interrupts the same, as is apparent from FIG. 2.

The penetration depth E of the recess 7 into the shaft 2, measured perpendicular to the axis 3 and perpendicular to the deepest area of the recess 7, is 10 to 50%, e.g. 35 to 45%, for example approximately 40%, of the diameter Di of the shaft 2. The minimum thickness of the area 8 of the shaft 2 left at the level of the recess 7 is therefore 90 to 50%, e.g. 65 to 55%, for example approximately 60%, of the diameter D₁ of the shaft 2.

There is no recess 7 in the tip 5, that is, the tip 5 is free of any recess 7, even in the case of multiple recesses 7 as is described later. However, the recess 7 is very close to the tip 5, that is, is arranged as close as possible behind the tip 5. For example, the end 9 of the recess 7 facing away from the tip 5 has a distance C₁ from the tip 5, that is, from its base B, which is at most five pitches H, e.g. at most four pitches H. The end 10 of the recess 7 facing the tip 5 has a distance C₂ from the tip 5 which is at least zero and at most four pitches H, e.g. at least half a pitch and at most three pitches H, for example one to two pitches H.

As is apparent from FIG. 2, the recess 7, viewed in the axial direction R, can have the shape of a circular segment. FIGS. 3 and 4 show alternative embodiments in which the or each recess 7, viewed in the axial direction R, has the shape of a circular or ellipsoidal sector. FIG. 4 shows the option of providing more than one recess 7 distributed over the circumference of the shaft 2. In the case of multiple recesses 7, each individual recess fulfills the aforementioned conditions described here for a recess 7. In particular, each recess 7 is kept clear of the tip 5, and its respective tip-facing end 9 has a distance C₁ of no more than five pitches H. However, the recesses 7 can otherwise be configured differently.

The recess 7 can have the shape of a rectangle, viewed perpendicular to a plane containing the axis 3, see FIG. 1. As an alternative, other shapes are also possible, for example the shape of a circular or ellipsoidal segment shown in FIG. 5.

The end of the shaft 2 facing away from the tip 5 can be designed in a variety of ways for the engagement of a tool or screwdriver. For example, the end can be fitted directly with a hexagon socket or the like. In the examples shown, a frustum-shaped transition section 11, which transitions into a cylindrical section 12 with a larger diameter D2 than the shaft diameter D₁, is contiguous to the end of the shaft 2 facing away from the tip 5. The cylindrical section 12 can, for example, be used for guidance in a cylindrical bore of a fitting, which is to be screwed to a component using the screw 1.

The head 4 can then be contiguous to the cylindrical section 12. The head 4 can, for example, in turn have a cylindrical part 13 with a larger diameter D₃ than the diameter D₂ of the cylindrical section 12, so that a shoulder 15 is formed therebetween. A widening countersink part 14 with a slot or cross recess for the engagement of a screwdriver or with a hexagon socket, six-lobe screw bit or other type of receptacle 16 for the engagement of a tool for turning the screw 1, is in turn contiguous to the cylindrical part 13.

The screw 1 can be made of any material, for example, plastic or metal, in particular steel or stainless steel.

The disclosed subject matter is not limited to the embodiments shown, but encompasses all variants, modifications, and combinations thereof that fall within the scope of the appended claims.

What is claimed is:

1. A self-tapping screw, having a cylindrical shaft with a central axis, to which cylindrical shaft a conical tip is coaxially contiguous, and a radially projecting cutting rib, which runs helically in windings over the cylindrical shaft and the conical tip, wherein the screw has a pitch and a distance between two adjacent windings in an axial direction is the pitch, and wherein the cylindrical shaft is provided with a lateral recess, which interrupts at least one winding of the cutting rib and penetrates into the cylindrical shaft up to at most half a diameter, wherein the conical tip is free of any recess and an end of the recess facing away from the conical tip has a distance from the conical tip which is at most five pitches.

2. The screw according to claim 1, wherein the end of the recess facing away from the conical tip has a distance from the conical tip which is at most four pitches.

3. The screw according to claim 1, wherein an end of the recess facing the conical tip has a distance from the conical tip which is at least half a pitch and at most three pitches.

4. The screw according to claim 3, wherein the end of the recess facing the conical tip has a distance from the conical tip which is one to two pitches.

5. The screw according to claim 1, wherein the recess, viewed in axial direction, has a shape of a circular segment.

6. The screw according to claim 1, wherein the recess, viewed in the axial direction, has a shape of a circular or an ellipsoidal sector.

7. The screw according to claim 1, wherein the recess, viewed perpendicular to a plane containing the axis, has the shape of a rectangle.

8. The screw according to claim 1, wherein the recess, viewed perpendicular to a plane containing the axis, has a shape of a circular or an ellipsoidal segment.

9. The screw according to claim 1, wherein a projecting height of the cutting rib on the conical tip progressively decreases to an apex of the conical tip.

10. The screw according to claim 1, wherein a penetration depth of the recess is 10-50% of the diameter of the cylindrical shaft.

11. The screw according to claim 1, wherein a penetration depth of the recess is 35-45% of the diameter of the cylindrical shaft.

12. The screw according to claim 1, wherein the cylindrical shaft transitions at an end facing away from the conical tip, via a widening transition section, into a cylindrical section with a larger diameter than the cylindrical shaft, to which section a head for engagement of a tool is contiguous.

13. The screw according to claim 12, wherein the head has a larger diameter than the cylindrical section and wherein a shoulder is formed between the head and the cylindrical section.

14. A self-tapping screw comprising:
a cylindrical shaft;
a conical tip having a base coupled to and being coaxial and contiguous with the cylindrical shaft at an end thereof, wherein the cylindrical shaft and conical tip include a radially projecting cutting rib extending in helical windings over the cylindrical shaft and the conical tip, wherein a distance between two adjacent windings in an axial direction defines a pitch, wherein the cylindrical shaft includes a recess which interrupts at least one winding of the cutting rib and extends not more than halfway into the cylindrical shaft, and wherein an end of the recess facing away from the conical tip has a distance from the base of the conical tip which is not more than five pitches.

15. The screw according to claim 14, wherein the end of the recess facing away from the conical tip has a distance from the base of the conical tip which is at most four pitches.

16. The screw according to claim 14, wherein an end of the recess facing the conical tip has a distance from the base of the conical tip which is at least half a pitch and at most three pitches.

17. The screw according to claim 14, wherein the recess, viewed in an axial direction, has a shape of a circular or an ellipsoidal sector.

18. The screw according to claim 14, wherein the recess, viewed perpendicular to a plane containing the axis, has a shape of a rectangle.

19. The screw according to claim 14, wherein the recess, viewed perpendicular to a plane containing the axis, has a shape of a circular or an ellipsoidal segment.

20. The screw according to claim 14, wherein a projecting height of the cutting rib on the conical tip progressively decreases to an apex of the conical tip.
